(19) United States
(12) Patent Application Publication
(10) Pub. No.: US 2019/0066667 A1
(43) Pub. Date: Feb. 28, 2019

(54) DETERMINING OUTPUT RECEIPT

(71) Applicant: Lenovo (Singapore) Pte. Ltd., Singapore (SG)

(72) Inventors: Russell Speight VanBlon, Raleigh, NC (US); Ryan Charles Knudson, Durham, NC (US); Roderick Echols, Chapel Hill, NC (US); Jonathan Gaither Knox, Morrisville, NC (US)

(21) Appl. No.: 15/686,329

(22) Filed: Aug. 25, 2017

(51) Int. Cl. G10L 15/22; G06F 3/16; G06F 3/01; G06F 3/0488

(52) U.S. Cl. CPC G10L 15/22; G06F 3/04883; G06F 3/013; G06F 3/16

(57) ABSTRACT

One embodiment provides a method, including: providing, responsive to receiving an indication at an information handling device, output to a user; determining, using a processor, whether the user has acknowledged the output; and clearing, responsive to determining that the user has acknowledged the output, the output. Other aspects are described and claimed.

### BACKGROUND

Digital assistants employed on information handling devices (“devices”), for example smart phones, tablet devices, smart speakers, laptop and personal computers, and the like, may be capable of providing various types of output to a user (e.g., alerts, notifications, received messages, etc.). The output may be provided using at least one of a variety of different types of output methods (e.g., audible output, visual output, etc.). Additionally, new outputs (e.g., new alerts, new notifications, etc.) may be provided without receiving an indication that a user has received and/or acknowledged one or more prior outputs.

### BRIEF SUMMARY

In summary, one aspect provides a method, comprising: providing, responsive to receiving an indication at an information handling device, output to a user; determining, using a processor, whether the user has acknowledged the output; and clearing, responsive to determining that the user has acknowledged the output, the output.

Another aspect provides an information handling device, comprising: a processor; a memory device that stores instructions executable by the processor to: provide, responsive to receiving an indication, output to a user; determine whether the user has acknowledged the output; and clear, responsive to determining that the user has acknowledged the output, the output.

A further aspect provides a product, comprising: a storage device that stores code, the code being executable by a processor and comprising: code that provides, responsive to receiving an indication, output to a user; code that determines whether the user has acknowledged the output; and code that clears, responsive to determining that the user has acknowledged the output, the output.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of determining whether a user has received output.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) responsive to receiving an indication to provide output (e.g., a user input requesting output, an alert, a notification, a received message, an incoming call, etc.).

Conventionally, digital assistants provide output each time an indication to provide output is received. For example, responsive to receiving an incoming text message, a digital assistant may provide an audible notification that the text message has been received. However, conventional digital assistants are unable to confirm that the user has received the audible output and/or heard what was said. Additionally, conventional digital assistants take no additional action (e.g., replay the audible message, etc.) to ensure that the message is actually communicated to the user. Therefore, if the user in the aforementioned example is engaged in an activity (e.g., talking to another individual, watching television, etc.) they may miss the important message.

Solutions exist for identifying that a user has looked at a piece of provided output. For example, eye tracking confirmation exists for users viewing emails, text messages, and the like. However, these solutions solely deal with confirming the receipt of visual output, but not audible output. As such, these solutions are ineffective in situations where audible output is the selected method of output provision (e.g., in situations where information communicated through visual output may be impractical such as while a user is driving, while a user's visual focus is occupied elsewhere, etc.).

Accordingly, an embodiment provides a method for clearing an output indication responsive to determining that the user has performed an acknowledgement action. In an embodiment, output may be provided to a user responsive to receiving an indication to provide output (e.g., responsive to receiving an alert, a notification, a text or email message, etc.). The output may be audible output and may be provided through an output device (e.g., speaker, another output device, etc.). An embodiment may then determine whether the user has acknowledged the output (e.g., by detecting user gaze at a predetermined location for a predetermined amount of time, by receiving confirmation input during a predetermined time, etc.). Responsive to determining that the user has acknowledged the output, an embodiment may clear the output (e.g., from a memory, etc.) and not repeat it. Such a method may enable devices to identify whether a user has received audibly provided output in order to ensure that they didn't miss an important message.

The illustrated example embodiments will be best understood by reference to the figures. The following description is intended only by way of example, and simply illustrates certain example embodiments.

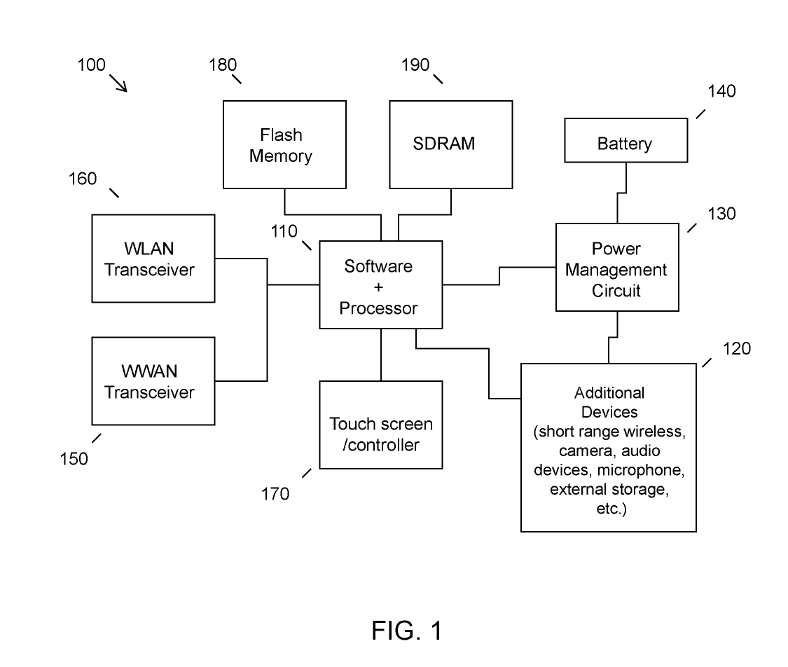

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes a touch screen 170 for data input and display/rendering. System 100 also typically includes various memory devices, for example flash memory 180 and SDRAM 190.

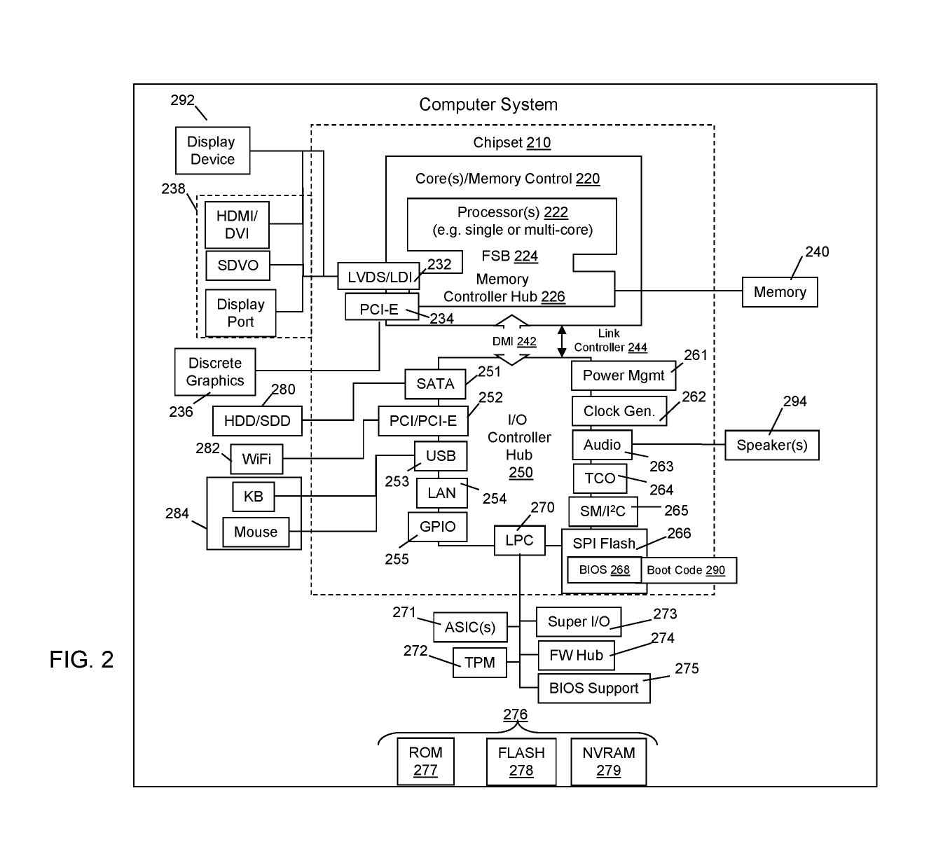

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

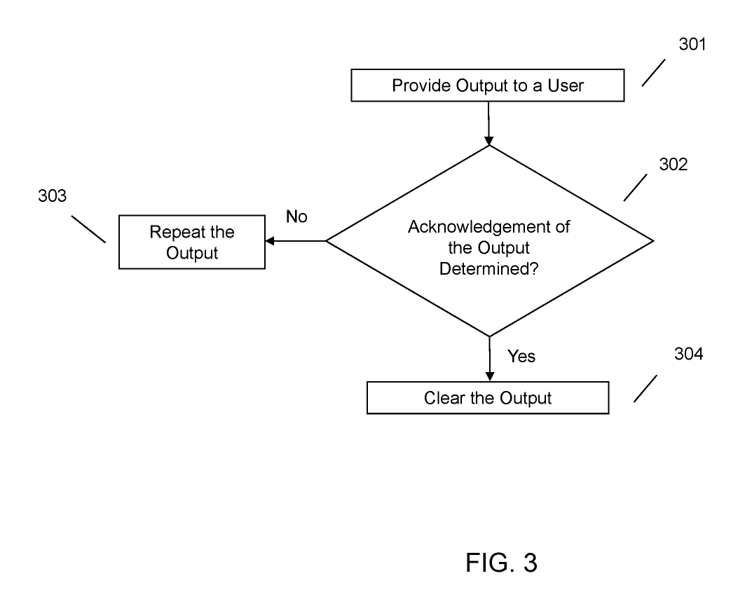

Referring now to FIG. 3, an embodiment may determine whether a user has received output. At 301, an embodiment may provide output responsive to receiving an indication to provide output. In an embodiment, the indication may be any indication received by a digital assistant to provide information to a user. For example, the indication may be associated with an alert (e.g., that a user has a meeting in 15 minutes, etc.), a notification (e.g., that a scheduled meeting has been moved to a different time, etc.), a received message (e.g., an email, a text message, a voice message, etc.), and the like. The indication may also include an indication that a response should be provided. For example, if a user has provided a query input, an embodiment may process and analyze the query input in order to provide an output responsive to the query input. The determination that this output is ready for provision to a user may be the indication to the digital assistant that audible output should be provided.

In an embodiment, the output may be audio output, visual output, a combination thereof, or the like. For simplicity purposes, the majority of the remaining discussion will involve audible output that may be provided by an audible output device (e.g., a speaker, another audible output device, etc.) operatively coupled to a digital assistant. However, it should be understood that generally any form of output may be provided. In an embodiment, the audible output may be provided through a speaker, another output device, and the like. In an embodiment, the audible output may be provided through an output device that may be integral to the device or may be located on another device. In the case of the latter, the output device may be connected via a wireless or wired connection to the device. For example, a smart phone may provide instructions to provide audible output through an operatively coupled smart speaker.

At 302, an embodiment may determine whether the user has acknowledged the output. A variety of determination methods are outlined below, one or more of which may be used to determine whether the user has acknowledged the output.

In an embodiment, gaze tracking may be used to determine that the user has acknowledged the output. Subsequent to providing audible output, an embodiment may detect whether a location of user's gaze falls on a predetermined location. In an embodiment, the user's gaze may be detected by a gaze detection device (e.g., an image sensor such as a camera, etc.). In an embodiment, the gaze detection device may be integral to the information handling device. For example, a smart phone may be disposed with a camera capable of capturing image data associated with a user. Alternatively, the gaze detection device may be disposed on another device and may transmit detection data to the information handling device. For example, images of a user may be captured by a dedicated, standalone camera and then subsequently transmitted to another device (e.g., to a user's smartphone for processing, etc.). Detection data may be communicated from other sources to the information handling device via a wireless connection (e.g., using a BLUEOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the gaze detection device may be configured to continuously receive image input data by maintaining the gaze detection device in an active state. The gaze detection device may, for example, continuously detect image data even when other sensors (e.g., microphones, light sensors, speakers, other cameras, etc.) associated with the information handling device are inactive. Alternatively, the gaze detection device may activate responsive to receiving an indication (e.g., the gaze detection device may activate subsequent to the provision of audible output, etc.) and may remain in an active state for a predetermined amount of time (e.g., 5 minutes, 10 minutes, 1 hour, etc.). Subsequent to not detecting user image data during this predetermined time window, an embodiment may switch the gaze detection device to a power off state. The predetermined time window may be preconfigured by a manufacturer or, alternatively, may be configured and set by one or more users.

In an embodiment, a predetermined location may correspond to a location of a user's gaze that signifies that a user is engaged with and/or capable of perceiving information provided by a digital assistant. For example, the predetermined location may include a portion of the device, for example, a display screen associated with a device, a location of the gaze detection device, a location of an output device associated with the device (e.g., speakers, etc.), and the like. The predetermined location may also be a location on or around the user. For example, the predetermined location may be a user's body part or a certain location in a room. The predetermined location may be preconfigured by a manufacturer or, alternatively, may be configured and set by one or more users.

In an embodiment, confirmation input may be provided by a user and the detection of which may be used in the determination of whether the user has acknowledged the output. The confirmation input may be received at an input device (e.g., on-screen keyboard, audio capture device, image capture device, video capture device, etc.) and may be provided by any known method of providing input to an electronic device (e.g., touch input, gesture input, voice input, etc.).

In an embodiment, the input device may be an input device integral to the information handling device (e.g., a smart phone may be disposed with a microphone capable of receiving voice input data) or, alternatively, may be disposed on another device and may transmit received input data to the information handling device (e.g., voice input may be received at a smart speaker that may subsequently transmit the voice data to another device, such as a user's smartphone, etc.). Input data may be communicated from other sources to the information handling device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like. In an embodiment, the input device may be configured to continuously receive input data by maintaining the input device in an active state, or, alternatively, may remain in an active state for a predetermined amount of time after provision of audible output (e.g., 30 seconds, 1 minute, 5 minutes, etc.). Subsequent to not receiving any voice input data during this predetermined time window, an embodiment may switch the input device to a power off state. The predetermined time window may be preconfigured by a manufacturer or, alternatively, may be configured and set by one or more users.

In an embodiment, the confirmation input may be received during duration of the provision of the audible output. For example, at any point while a digital assistant is audibly outputting the contents of an alert notification, a user may look at a display screen associated with the digital assistant. The detection of the user's gaze on the screen may be considered confirmation input and may be used as an indication that the user has acknowledged the output. In another embodiment, the confirmation input may be received within a predetermined time period (e.g., 30 seconds, 1 minute, 5 minutes, etc.) after provision of the output. For example, if a user provides confirmation voice input to the device (e.g., “sounds good”, “okay”, etc.) 5 seconds after the device audibly provides the output, an embodiment may consider the received voice input to be confirmation input and may use this input in determining that the user has acknowledged the output.

An embodiment may dynamically determine that a user has not acknowledged receipt of the contents of the output based upon receiving post-output input. In an embodiment, post-output input may comprise a user query associated with the output. For example, subsequent to audibly providing output to a user, an embodiment may receive a query from the user, e.g., “what did you say”, “can you repeat that”, etc. An embodiment may determine, based upon the received query, that a user did not hear or understand the contents of the original output.

In an embodiment, priority levels may be pre-assigned and attached to different outputs and may be dependent upon, for example, output type (e.g., alert, notification, text message, etc.), output affiliation (work-based output, personal output, etc.), the sender of information associated with the output (boss, spouse, etc.), and the like. For example, all work-based output (e.g., meeting alerts, scheduling notifications, etc.) may be assigned a high priority level whereas all personal output (e.g., messages from friends, etc.) may be assigned a standard priority level. In an embodiment, priority levels may be assigned by the manufacturer or may be set by a user. In another embodiment, priority levels may be determined and assigned dynamically. For example, an embodiment may analyze the content of information associated with the output (e.g., using one of a variety of content analysis techniques known in the art, etc.) and dynamically determine whether the output is high priority output.

In an embodiment, a determination may be made that the output corresponds to a high priority output and, responsive to this determination, an embodiment may provide additional output signaling to a user that the output is high priority. The additional output may, for example, alert the user that a digital assistant has provided or is providing high priority output that they should listen to. In an embodiment, the additional output may be a notification that serves to notify a user that output is high priority. The notification may be, for example, a blinking light, a stagnant light (i.e., a light that does not blink and remains on), an audible notification (e.g., a beep, another sound, etc.), a visual notification (e.g., a message, picture, or other visual notification provided on a display associated with the device), and the like. In an embodiment, the notification may be on-going until it is determined that a user has acknowledged the output. Responsive to determining that a user has acknowledged the output, the notification may cease.

Responsive to determining, at 302, that a user has acknowledged the output, an embodiment may, at 304, clear the output indication. In an embodiment, an indication to provide the output may be present in a device's memory until a user has acknowledged the output. Upon determining that the user has received the output, an embodiment may clear this notification or indication. In an embodiment, responsive to determining that output corresponds to high priority output, an embodiment may require a user to provide confirmation input prior to clearing the output indication. For example, a user may provide audible input indicating that they have received the output (e.g., “I have read the message”, etc.). Responsive to receiving the confirmation input, an embodiment may clear the output indication.

Responsive to determining, at 302, that a user has not acknowledged the output, an embodiment may, at 303, repeat the audible output. In an embodiment, the non-acknowledged output may be repeated a predetermined amount of times (e.g., 5 times, 10 times, etc.), for a predetermined amount of time (e.g., once every 10 seconds for 2 minutes, etc.), or repeatedly at a fixed rate (e.g., once every 10 seconds, etc.) until it is determined that a user has acknowledged the output. In an embodiment, a digital assistant may not provide another type of output notification until it has determined that a user has acknowledged the previous output. For example, a digital assistant may not provide output associated with an incoming text message until a user has acknowledged receipt of a previously output notification.

The various embodiments described herein thus represent a technical improvement to conventional output provision techniques. Using the techniques described herein, an embodiment may provide output to a user responsive to receiving an indication to provide output. An embodiment may then determine whether the user has acknowledged the output (e.g., using gaze tracking, receiving confirmation input, etc.) and, responsive to a positive determination, an embodiment may clear an indication to repeatedly provide the output. Such techniques ensure that a user receives messages output by a device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
providing, responsive to receiving an indication at an information handling device, output to a user;
identifying, using a processor, a priority level associated with the output, the priority level being one of: a high priority level and a low priority level;
determining, responsive to identifying that the output is associated with a high priority level and using a processor, whether the user has acknowledged the output; and
clearing, only after determining that the user has acknowledged the output, the output.

2. The method of claim 1, wherein the determining that the user has acknowledged the output comprises detecting user gaze at a predetermined location for a predetermined amount of time.

3. The method of claim 2, wherein the predetermined location comprises at least a portion of the information handling device.

4. The method of claim 1, wherein the determining that the user has acknowledged the output comprises receiving confirmation input from the user.

5. The method of claim 4, wherein the receiving comprises receiving confirmation input during at least one of a duration of the provision of the output and a predetermined time period after provision of the output.

6. The method of claim 4, wherein the confirmation input comprises receiving user confirmation input selected from the group consisting of audible confirmation input, gesture confirmation input, and touch confirmation input.

7. The method of claim 1, further comprising determining that the user has not acknowledged the output responsive to receiving, after provision of the output, a user query associated with the output.

8. The method of claim 1, further comprising repeating, responsive to determining that the user has not acknowledged the output, the output.

9. (canceled)

10. The method of claim 1, further comprising receiving audible user acknowledgement input prior to clearing the output.

11. An information handling device, comprising:
a processor;
a memory device that stores instructions executable by the processor to:
provide, responsive to receiving an indication, output to a user;
identify a priority level associated with the output, the priority level being one of:
a high priority level and a low priority level;
determine, responsive to identifying that the output is associated with a high priority level, whether the user has acknowledged the output; and
clear, only after determining that the user has acknowledged the output, the output.

12. The information handling device of claim 11, wherein the instructions executable by the processor to determine that the user has acknowledged the output comprise instructions executable by the processor to detect user gaze at a predetermined location for a predetermined amount of time.

13. The information handling device of claim 12, wherein the predetermined location comprises at least a portion of the information handling device.

14. The information handling device of claim 11, wherein the instructions executable by the processor to determine that the user has acknowledged the output comprise instructions executable by the processor to receive confirmation input from the user.

15. The information handling device of claim 14, wherein the instructions executable by the processor to receive comprise instructions executable by the processor to receive confirmation input during at least one of a duration of the provision of the output and a predetermined time period after provision of the output.

16. The information handling device of claim 14, wherein the confirmation input comprises receiving user confirmation input selected from the group consisting of audible confirmation input, gesture confirmation input, and touch confirmation input.

17. The information handling device of claim 11, wherein the instructions are further executable by the processor to determine that the user has acknowledged the output responsive to receiving, after provision of the output, a user query associated with the output.

18. (canceled)

19. The information handling device of claim 11, wherein the instructions are further executable by the processor to receive audible user acknowledgement input prior to marking the output as received.

20. A product, comprising:
a storage device that stores code, the code being executable by a processor and comprising:
code that provides, responsive to receiving an indication, output to a user;
code that identifies a priority level associated with the output, the priority level being one of: a high priority level and a low priority level;
code that determines, responsive to identifying that the output is associated with a high priority level, whether the user has acknowledged the output; and
code that clears, only after determining that the user has acknowledged the output, the output.
